(19) United States
(12) Patent Application Publication
(10) Pub. No.: US 2006/0244995 A1
(43) Pub. Date: Nov. 2, 2006

(54) Printing system having pull printing function

(75) Inventor: Tsuyoshi Kushida, Iwakura-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: BROTHER KOGYO KABUSHIKI KAISHA, Nagoya-shi (JP)

(21) Appl. No.: 11/413,200

(22) Filed: Apr. 28, 2006

(30) Foreign Application Priority Data
Apr. 28, 2005 (JP) 2005-132872

(51) Int. Cl. G06F 3/12

(52) U.S. Cl. 358/1.15; 709/203

(57) ABSTRACT

A printing system includes a printing device and a server device connected with each other via a communication line. The printing device includes a request-information transmitting portion that transmits print-data request information to the server device. The server device includes a print-data providing portion that transmits print data to the printing device in response to the print-data request information received from the printing device. The printing device further includes an identification-information transmitting portion that transmits user-identification information to the server device.

### CROSS REFERENCE TO RELATED APPLICATIONS

This application claims priority from Japanese Patent Application No. 2005-132872 filed Apr. 28, 2005. The entire content of the priority application is incorporated herein by reference.

### TECHNICAL FIELD

The disclosure relates to a printing system including a server device and a printing device connected with each other via a communication line. The disclosure also relates to the printing device, the server device, and programs for the printing device and the server device.

### BACKGROUND

Technologies such as that disclosed in Japanese Patent Application Publication No. 2002-297335 have been proposed for a “pull printing” function in which a printer accesses data on a server and acquires certain data therefrom for printing. With this technology, the user can easily obtain required data by performing operations on a printer.

### SUMMARY

However, these proposed technologies allow anyone, regardless of the type of user, to access the server and to receive and print data from the server on a printer. The server simply transmits the requested data without knowing what type of user is requesting the data, without learning the users that are interested in specific data, and without employing a format for restricting the provision of data to specific users, for example. Further, since the server provides all data without regard for who the user is, the user cannot require data that is associated with the user.

In view of the foregoing, it is an object of the invention to provide a printing system, a printing device, a server device, and programs for a printing device and a server device capable of transmitting print data depending on the user who requests data.

In order to attain the above and other objects, one aspect of the invention provides a printing system. The printing system includes a printing device and a server device connected with each other via a communication line. The printing device includes a request-information transmitting portion that transmits print-data request information to the server device. The server device includes a print-data providing portion that transmits print data to the printing device in response to the print-data request information received from the printing device. The printing device further includes an identification-information transmitting portion that transmits user-identification information to the server device.

According to another aspect, the invention provides a printing device. The printing device includes a request-information transmitting portion and an identification-information transmitting portion. The request-information transmitting portion transmits print-data request information to a server device connected with the printing device via a communication line. The identification-information transmitting portion transmits user-identification information to the server device.

According to another aspect, the invention provides a server device. The server device includes a print-data providing portion and an acquiring portion. The print-data providing portion transmits print data, to a printing device connected with the server device via a communication line, in response to print-data request information transmitted from the printing device. The acquiring portion acquires user identification information transmitted from the printing device in association with the print data.

According to another aspect, the invention provides a storage medium for storing a program for a printing device. The program includes a program of transmitting print-data request information to a server device connected with the printing device via a communication line, and a program of transmitting user-identification information to the server device.

According to another aspect, the invention provides a storage medium for storing a program for a server device. The program includes a program of transmitting print data, to a printing device connected with the server device via a communication line, in response to print-data request information transmitted from the printing device, and a program of acquiring user identification information transmitted from the printing device in association with the print data.

### BRIEF DESCRIPTION OF THE DRAWINGS

Illustrative aspects in accordance with the invention will be described in detail with reference to the following figures wherein:

FIG. 1 is a block diagram showing the structure of a printing system according to a first example of the invention;

FIG. 2A is a table illustrating a data structure for data stored in a personal information storage area on a hard disk of the server computer;

FIG. 2B is a table illustrating a data structure for data stored in a print data storage area on the hard disk of the server computer;

FIG. 3 is a perspective view showing the external appearance of a printer;

FIG. 4 is a flowchart illustrating steps in a control process according to a program for the printer;

FIG. 5 is a flowchart illustrating steps in a QR code reading process;

FIG. 6 is a flowchart illustrating steps in a control process for a server program;

FIG. 7 is a flowchart illustrating steps in a QR code reading process according to a second example of the invention;

FIG. 8 is a flowchart illustrating steps in a control process performed on the printer in response to an authorization process according to a third example of the invention;

FIG. 9 is a flowchart illustrating steps in a control process performed on a server computer in response to the authorization process;

FIG. 10A is an explanatory drawing showing the configuration of a request message transmitted by a printer;

FIG. 10B is an explanatory drawing showing the configuration of a response message transmitted by a server; and

FIG. 10C is a table showing the data structure of data stored in a print data storage area according to a modification.

### DETAILED DESCRIPTION

### First Example

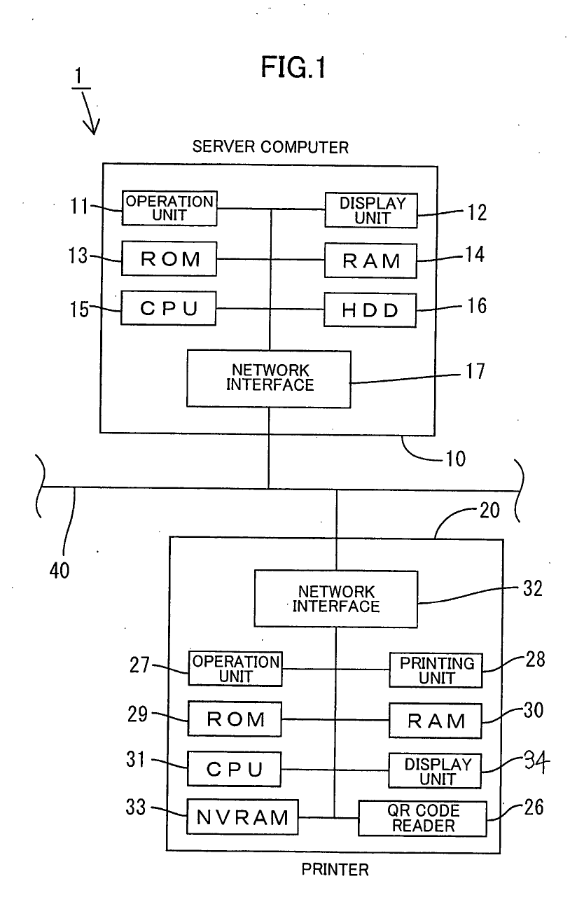

A printing system, a printing device, a server device, a program for a printing device, and a program for a server device according to a first example of the invention will be described with reference to FIGS. 1 through 6.

1. Structure of the Printing System

FIG. 1 is a block diagram showing the structure of a printing system 1 according to the first example. The printing system 1 is configured of a server computer 10 and a printer 20 that are both connected to an Internet 40 via respective network interfaces 17 and 32, for example, and can thereby achieve bi-directional data communications with each other. By performing a predetermined operation on the printer 20, the user can direct the printer 20 to transmit, to the server computer 10, a request message requesting desired print data. Under predetermined conditions, the server computer 10 returns the print data in accordance with the request message to the printer 20 so that the printer 20 can print out the data.

(1) Server Computer

The server computer 10 includes an operation unit 11 for receiving input operations from an external unit (keyboard, mouse, or the like), a display unit 12 for displaying user identification information and the like described later, a ROM 13, a RAM 14, a CPU 15, a hard disk 16, and the network interface 17. The hard disk 16 stores programs and the like executed on the server computer 10. The CPU 15 reads the server programs and the like from the hard disk 16 based on commands from the operation unit 11 and launches the programs.

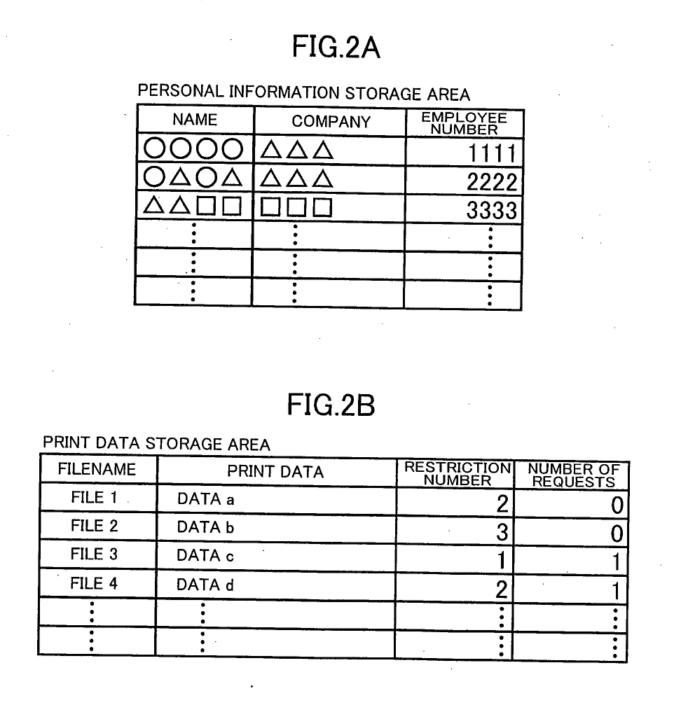

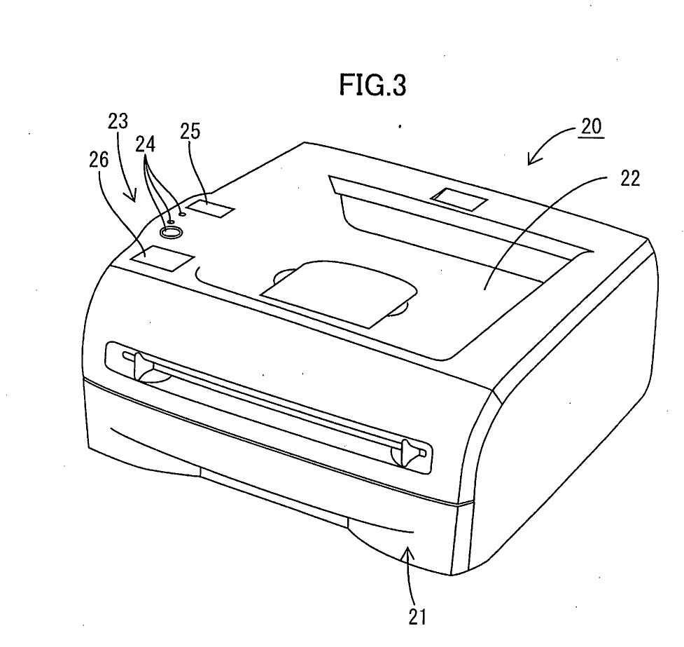

The hard disk 16 has a personal information storage area (FIG. 2A) for storing personal information on users for allowing the provision of print data, and a print data storage area (FIG. 2B) for storing print data to be provided. As shown in FIG. 2A, the personal information storage area includes a username, company name, employee number, or the like associated with each user. As shown in FIG. 2B, the print data storage area includes a filename, print data, a provision restriction number, and an actual number of requests for entry.

As will be described later, when the server computer 10 receives a request message from the printer 20, the server computer 10 reads print data (data a, data b, data c, where the data type is XML or PDL data, for example) for the filename specified in the request message (file 1, file 2, file 3, . . . ) from the print data storage area under predetermined conditions. The server computer 10 then transmits the print data read above via the network interface 17.

(2) Printer

FIG. 3 is a perspective view showing the outer appearance of the printer 20. The printer 20 has an overall box shape. The printer 20 includes a paper cassette 21 for accommodating a recording paper that is disposed in a bottom section of the printer 20 and can be pulled out therefrom; a discharge tray 22 provided on the top surface of the printer 20 for receiving the discharged recording paper after the paper is supplied from the paper cassette 21 and subjected to a printing process; and an operation panel 23 disposed to the side of the discharge tray 22. The operation panel 23 includes operating buttons 24 by which the user can perform various operations, and a display device 25 such as a liquid crystal panel for displaying characters, symbols, graphics, and the like.

In the present example, the printer 20 is also provided with a QR code reader 26 capable of reading QR codes. As will be described later, the printer 20 can read user identification information and link destination information for print data based on the QR code read by the QR code reader 26.

The block diagram in FIG. 1 shows an abbreviated construction of the printer 20. As shown in FIG. 1, the printer 20 includes an operation unit 27 for receiving push operations from the operating buttons 24 of the operation panel 23, a printing unit 28 for controlling printing operations on recording paper, a ROM 29, a RAM 30, a CPU 31, and the network interface 32.

The CPU 31 performs a printer language process (PDL process for PDL data, for example) on print data received from the server computer 10 via the network interface 32 and transmits the resulting data to the printing unit 28. The printing unit 28 performs a printing operation based on data received from the CPU 31 to print an image in accordance with the print data on the recording paper.

The printer 20 also includes a display unit 34 for controlling the display pattern on the display device 25, the QR code reader 26 described earlier, and an NVRAM 33. The NVRAM 33 stores programs for the printer 20, user identification information inputted into the printer 20, as will be described later, error message information, and the like.

2. Operations of the Printing System

The QR code read by the QR code reader 26 includes the following items.

(a) A QR code a printed on a predetermined document, poster, or the like and including link destination information (URL (uniform resource locator) information in the present example) indicating a destination at which specific print data is saved (but not including user identification information described below).

(b) A QR code b printed on a company ID card or the like and including user identification information such as an employee name, company name, employee number, or the like (but not including the URL information described above).

(c) A QR code c printed on a predetermined document or the like and including the URL information and user identification information described above.

(1) Control Process on the Printer Side

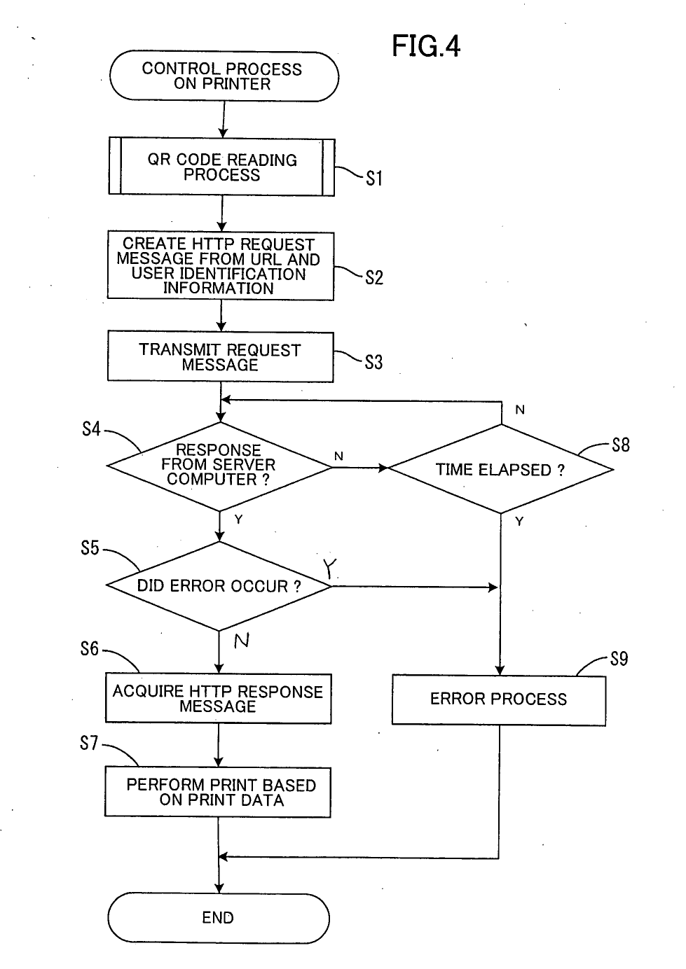

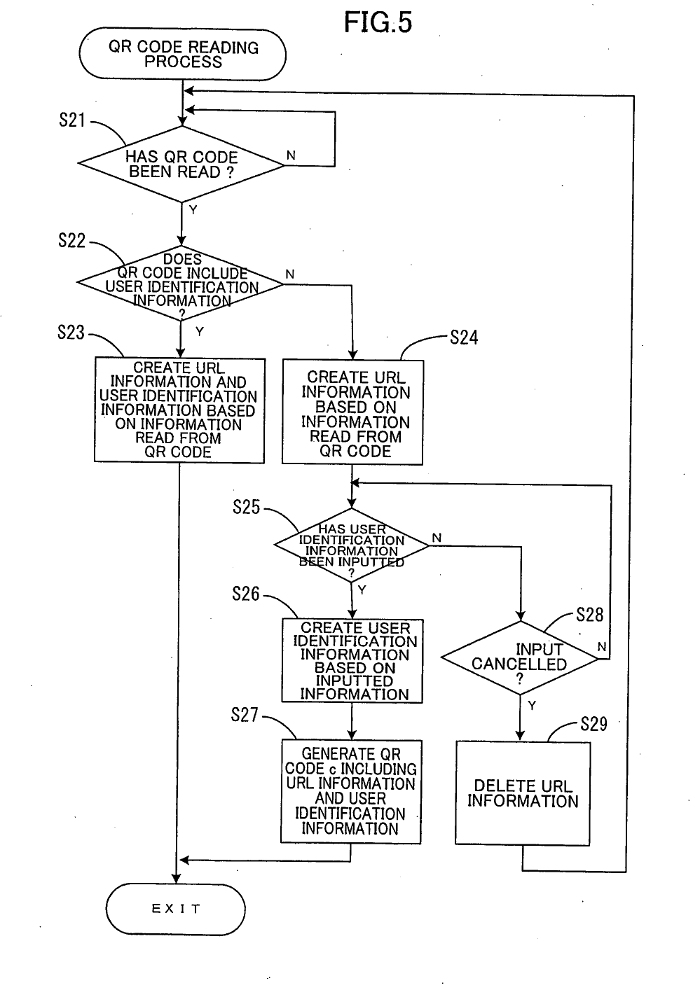

To begin with, the user places a QR code that has been printed on a predetermined document against the QR code reader 26 and inputs a predetermined operation via the operating buttons 24. By doing so, a control process on the printer side is executed, as shown in the flowchart of FIG. 4. In S1 the QR code reader 26 executes a reading process shown in detail in the flowchart of FIG. 5.

In S21 of FIG. 5 the CPU 31 determines whether the QR code reader 26 has performed a reading operation. If the QR code reader 26 has performed a reading operation (S21: YES), then in S22 the CPU 31 determines whether the QR code read by the QR code reader 26 includes user identification information. If the QR code read by the QR code reader 26 is the QR code c having both URL information and user identification information (S22: YES), then in S23 the CPU 31 creates the URL information and the user identification information and returns to the process in FIG. 4.

However, if the QR code is the QR code a, which has URL information but no user identification information (S22: NO), then in S24 the CPU 31 creates URL information. In S25 the CPU 31 determines whether user identification information has been inputted. For example, the user may operate the operating buttons 24 on the operation panel 23 to input the user's own identification information. In the present example, there is another method for inputting user identification information in which the QR code reader 26 reads a QR code b containing the user identification information.

User identification information inputted through one of these input methods is stored in the NVRAM 33. If user identification information has been stored in the NVRAM 33, after S24 this data is displayed on the display device 25 (when a plurality of user identification information entries are stored in the NVRAM 33, the entries can be displayed in sequence by operating the operating buttons 24). Hence, if the user identification information for a user is already stored in the printer 20, the user can simply operate the operating buttons 24 to select the user's own user identification information from the data displayed on the display device 25, eliminating the need to repeat input operations.

If user identification information has been inputted (S25: YES), then in S26 the CPU 31 creates user identification information based on the inputted information. In S27 the CPU 31 generates a QR code c including URL information read from the QR code a and the user identification information inputted according to one of the above input methods, and stores the QR code c in the NVRAM 33, for example. The QR code c stored in the NVRAM 33 is used for printing the QR code c in S7, as will be described later.

However, if user identification information has not been inputted (S25: NO), then in S28 the CPU 31 determines whether input has been cancelled. If input has not been cancelled (S28: NO), then the CPU 31 returns to S25. However, if input has been cancelled (S28: YES), then in S29 the CPU 31 executes an initialization process to delete the URL information created in S24, and subsequently returns to S21.

After the QR code reading process is completed, in S2 of FIG. 4 the CPU 31 creates a request message according to HTTP protocol from the URL information and user identification information acquired in the QR code reading process and in S3 transmits this request message to the server computer 10. When using active server pages (ASP), for example, URL information such as that shown below is included in the request message.

http://www.xxx.co.jp/info/sampledata.asp?Name=XXX&Company=YYYY

In this data, “http://www.xxx.co.jp/info/sampledata.asp” is the URL indicating the destination at which the print data is stored, including the domain name, directory name, and filename. Further, “?Name=XXX&Company=YYYY” is an ASP argument generated from the user identification information. This information may also be encrypted.

In S4 the CPU 31 determines whether a response has been received from the server computer 10. If a response has been received (S4: YES), then in S5 the CPU 31 determines whether the response is an error response message indicating that an error has occurred. If the response is not an error response message (S5: NO), then in S6 the CPU 31 acquires the response message in HTTP protocol. In S7 the CPU 31 reads print data stored in the message body of the response message, for example, and controls the printing unit 28 to execute a printing process for printing an image based on this print data on recording paper. In this way, the user can acquire desired data. At this time, in the present example, the QR code c generated in S27 of FIG. 5 is printed on the same recording paper on which the image is printed or on a separate sheet of recording paper. By printing the QR code c, the user only need to perform a QR code reading operation once (reading a QR code c) next time the user wishes to print the same print data. Otherwise, the user need to perform QR code reading operations twice, that is, reading a QR code a and also reading a QR code b. The printer 20 may also be configured to print the QR code c on a sheet of recording paper in the process of S27 described above.

However, if in S4 no response is detected from the server computer 10 by the time the predetermined time has elapsed (S4: N0, S8: YES), then the CPU 31 determines that some type of communication error with the server computer 10 has occurred. Alternatively, if an error response message was received (S4: YES, S5: YES), then the CPU 31 determines that an authorization error with respect to the user identification information, a restriction error regarding the number of data requests, or the like has occurred at the server computer 10, as will be described later. Therefore, in S9 the CPU 31 reads an error message corresponding to the communication error described above from the NVRAM 33 or reads an error message corresponding to the authorization error or restriction error from the received error response message, and executes an error process in which the printing unit 28 is controlled to print the error message on a sheet of recording paper.

(2) Control Process on the Server Computer Side

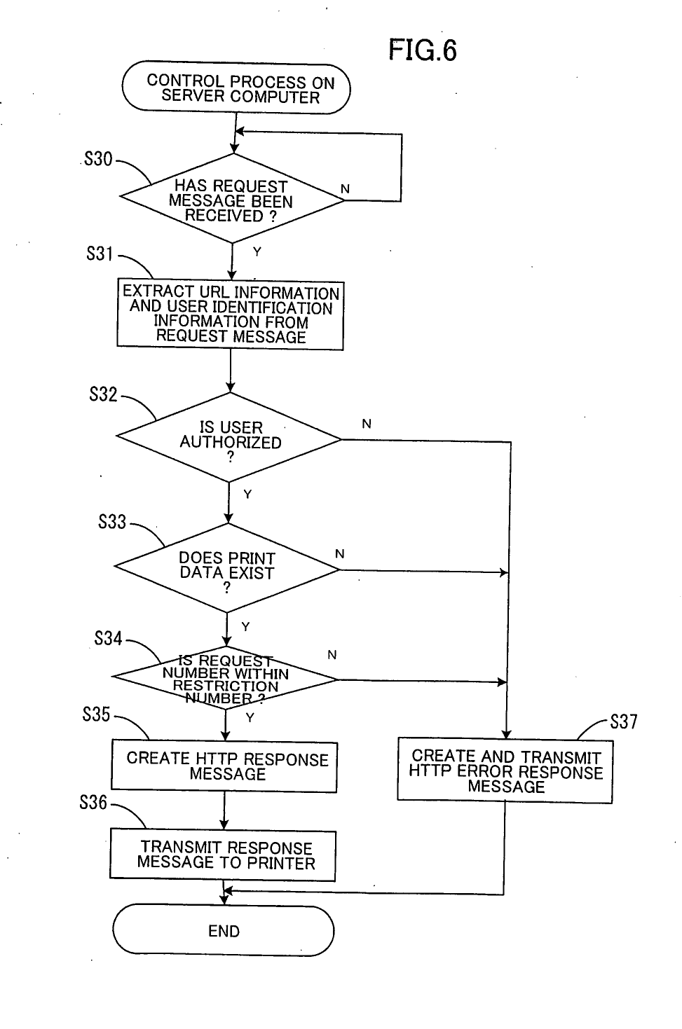

Next, the control process executed by the CPU 15 on the server computer 10 will be described with reference to the flowchart in FIG. 6. In S30 of FIG. 6 the CPU 15 is in a wait state waiting for a request message from the printer 20. When a request message is received (S30: YES), in S31 the CPU 15 extracts the URL information and user identification information from the request message. In S32 the CPU 15 determines whether the user is authorized based on whether the acquired user identification information matches personal information (See FIG. 2A) stored in the personal information storage area of the hard disk 16. If the user is authorized (S32: YES), then in S33 the CPU 15 determines whether print data is stored at the storage address based on the URL information. In other words, the CPU 15 acquires the user identification information transmitted from the printer 20 in association with the print data.

If print data exists at the address (S33: YES), then in S34 the CPU 15 determines whether the print data has a restriction number which is the number of times the print data can be provided and, if so, whether the current number of requests for the print data incremented by 1 is less than or equal to the restriction number. For example, another request for the data c in FIG. 2B exceeds the restriction number of 1.

If the current request is less than or equal to the restriction number (S34: YES), then in S35 the CPU 15 creates a response message according to HTTP protocol that includes the print data and in S36 transmits the response message to the printer 20.

However, if user authorization fails in S32 (S32: NO), if no print data exists at the indicated address (S33: NO), or if the current request exceeds the restriction number (S34: NO), then in S37 the CPU 15 creates and transmits an error response message to the printer 20 according to HTTP protocol and including a message corresponding to the type of error.

3. Effects of the First Example

(1) In the printing system 1 according to the first example described above, the printer 20 attaches user identification information to a request message that requests print data. Hence, by storing the user identification information in association with the print data on the server computer 10, the server computer 10 can control which users request what print data.

(2) Further, by authorizing users that are allowed to obtain data based on the user identification information, the server computer 10 can reliably provide data to only specific users.

(3) Further, if a restriction is provided with print data regarding the number of times the data can be provided to specific users, the server computer 10 can restrict provision of data when the number of requests for the data exceeds the restriction number.

(4) The printer 20 is configured to print an error message included in an error response message received from the server computer 10 on recording paper, rather than displaying the message on the display device 25. Accordingly, there is no need to increase the display area of the display device 25 in order to display error messages containing a large amount of information.

(5) Once a user has requested print data through the printer 20 and has inputted the user identification information thereon, the user identification information for this user is stored in the NVRAM 33. Hence, in subsequent requests, the user need only select the proper user identification information from data displayed on the display device 25.

### Second Example

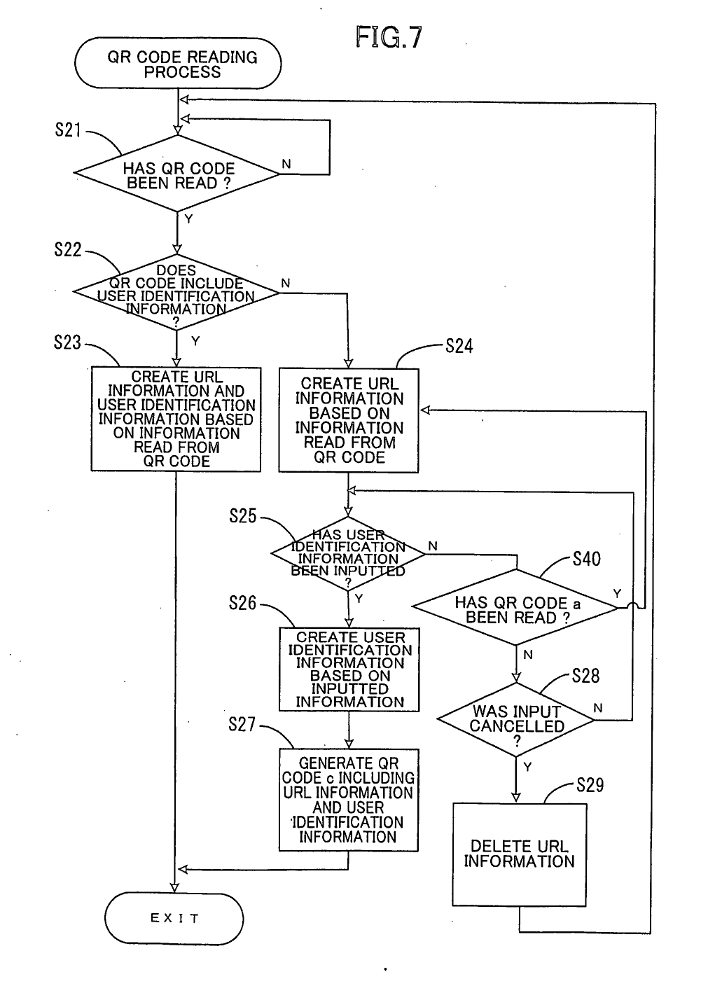

Next, a printing system according to a second example of the invention will be described with reference to FIG. 7. The second example differs from the first example in the QR code reading process. Since the remaining configuration of the printing system 1 is identical to that in the first example, like parts and components are designated with the same reference numerals to avoid duplicating description.

FIG. 7 is a flowchart showing the QR code reading process according to the second example. The QR code reading process according to the second example is nearly identical to that described in the first example, but a step S40 is added. More specifically, when the CPU 31 determines in S25 that no user identification information has been inputted (S25: NO), then in S40 the CPU 31 determines whether the QR code reader 26 has read a QR code a having other URL information. If the QR code reader 26 has read such data (S40: YES), then the CPU 31 returns to S24 to create and store other URL information based on the data read from the QR code a. However, if the QR code reader 26 has not read a QR code a (S40: NO), then the CPU 31 advances to S28 and continues the process described in the first example.

When user identification information does exist (S25: YES), then in S26 the CPU 31 creates user identification information based on the inputted information. Subsequently, in S27 the CPU 31 generates a QR code c that includes URL information for a plurality of print data stored thus far and the user identification information. In other words, when user identification information has been inputted after QR codes a having URL information have been read a plurality of times, all of the URL information is determined to be print requests for print data by a user corresponding to the user identification information, and the QR code c is generated with this URL information. Subsequently, in S2 of FIG. 4 the CPU 31 creates a request message configured of the user identification information and the plurality of URL information for print data.

This construction eliminates the need to input user identification information through the printer 20 for each print data that is requested.

### Third Example

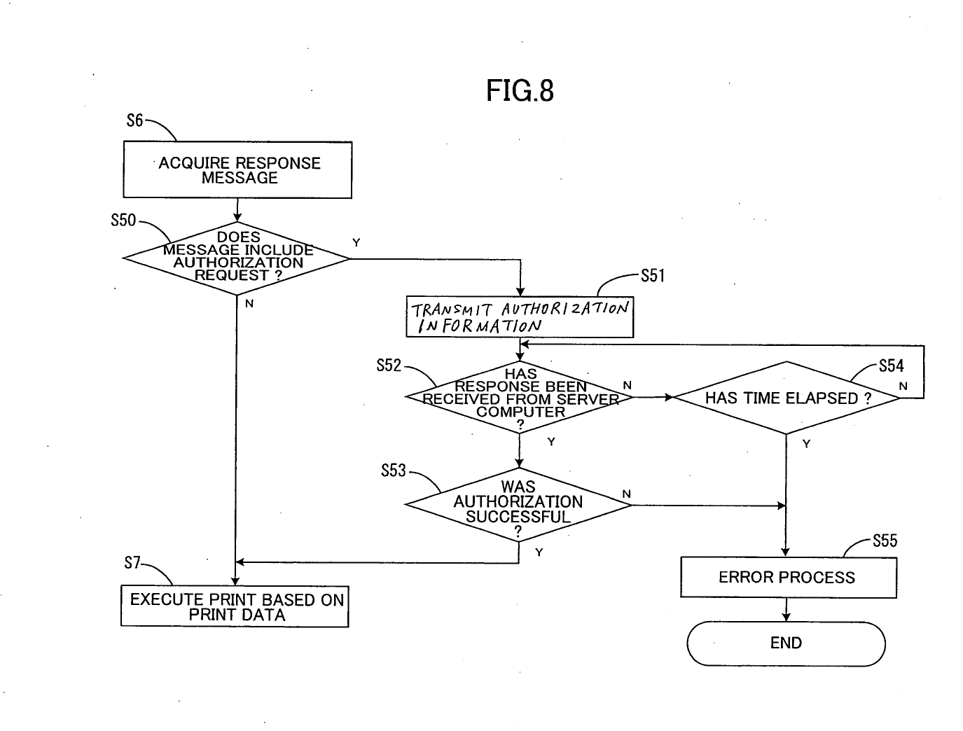

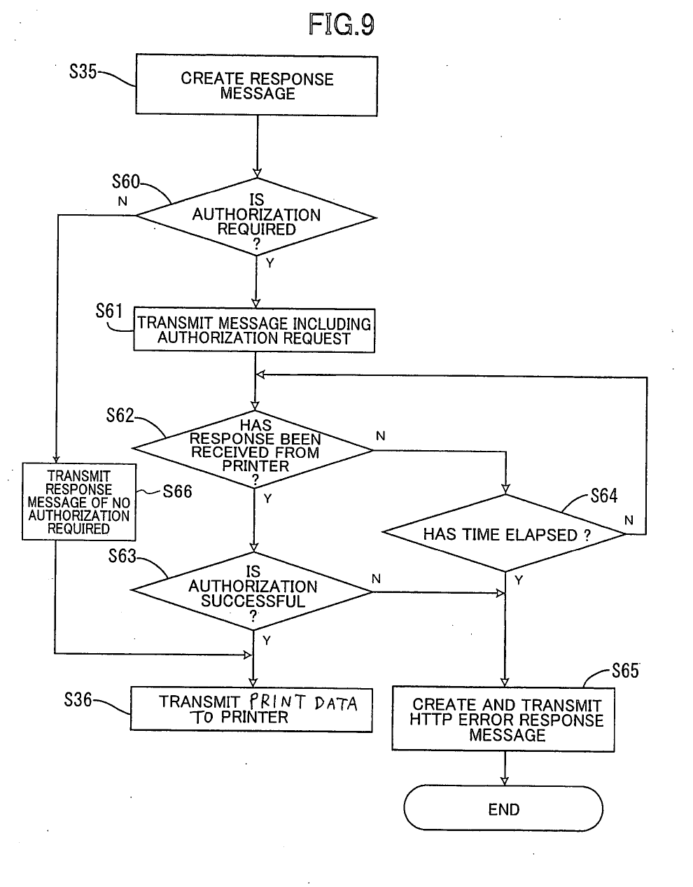

Next, a printing system according to a third example of the invention will be described with reference to FIGS. 8 and 9. The third example differs from the first example only in a method of user authorization. Since the remaining configuration of the printing system 1 is identical to that in the first example, like parts and components are designated with the same reference numerals to avoid duplicating description. In the third example, the user authorization step in FIG. 6 (S32) is not performed. FIG. 8 is a flowchart showing steps in the user authorization process of the third example performed on the printer 20. FIG. 9 is a flowchart showing steps in the user authorization process performed on the server computer 10.

As shown in FIG. 8, after the CPU 31 of the printer 20 acquires a response message in S6 of FIG. 4, in S50 the CPU 31 determines whether a message including an authorization request is described in the response message. If no authorization request is included (S50: NO), then in S7 the CPU 31 acquires the print data from the server computer 10 and executes a printing process. However, if the message includes an authorization request (S50: YES), then in S51 the CPU 31 transmits the user identification information stored in S1 (S27) to the server computer 10 as authorization information.

In S52 the CPU 31 determines whether a response has been received from the server computer 10 and, if not (S52: NO), determines in S54 whether a predetermined time has elapsed. As long as the predetermined time has not elapsed (S54: NO), the CPU 31 continually loops back to S52. If a response is received from the server computer 10 (S52: YES), then in S53 the CPU 31 determines whether the response indicates that authorization was successful. If the authorization was successful (S53: YES), then in S7 the CPU 31 acquires print data from the server computer 10 and executes the printing process.

However, if a response is not received from the server computer 10 within the predetermined time (S52: N0, S54: YES) or when a response was received but the response indicates that authorization failed (S52: YES, S53: NO), then in S55 the CPU 31 outputs an error message corresponding to the type of error to be printed on recording paper.

In the meantime, after the CPU 15 on the server computer 10 creates the response message in S35, in S60 of FIG. 9 the CPU 15 determines whether the requested print data requires authorization. If authorization is required (S60: YES), then in S61 the CPU 15 transmits a response message including an authorization request to the printer 20. In S62 the CPU 15 determines whether a response including authorization information has been received from the printer 20. While a response has not been received from the printer 20 (S62: NO), the CPU 15 determines in S64 if a predetermined time has elapsed. As long as the predetermined time has not elapsed (S64: NO), the CPU 15 continues to loop back to S62. If a response including authorization information is received from the printer 20 (S62: YES), then in S63 the CPU 15 checks authorization by comparing the authorization information with predetermined reference information. If the authorization information successfully matches the reference information (i.e., valid authorization information) (S63: YES), then in S36 the CPU 15 transmits the print data to the printer 20.

However, if no response has been received from the printer 20 within the predetermined time limit (S62: N0, S64: YES) or when the authorization failed (S62: YES, S63: NO), then in S65 the CPU 15 creates an error response message in HTTP protocol that includes an error message indicating that authorization failed and the like and transmits this error response message to the printer 20. Alternatively, the CPU 15 may cancel the communication process with the printer 20 and return to a wait state.

Further, after the response message is created in S35, and when the CPU 15 determines in S60 that the requested print data does not require authorization (S60: NO), then in S66 the CPU 15 transmits a response message without an authorization request to the printer 20 and in S36 transmits the print data to the printer 20.

The authorization information transmitted in S51 may be a password. In this case, in S51 the CPU 31 displays a message on the display device 25 requesting the user to input a password and, after a password has been inputted, transmits the inputted password to the server computer 10.

While the invention has been described in detail with reference to the above aspects thereof, it would be apparent to those skilled in the art that various changes and modifications may be made therein without departing from the spirit of the invention.

(1) While a QR code is used in the above-described examples, the invention is not limited to two-dimensional codes, but may be a barcode, provided that the amount of information is not large.

(2) In the above-described examples, the server computer 10 and printer 20 are connected via the network interfaces 17, 32 with the Internet 40 and are capable of communicating with each other. However, the method of connection is not limited to a public communication line such as the Internet, telephone line, and ISDN, but may be configured of an intranet such as an in-house LAN. Further, the server computer 10 and printer 20 may be connected locally through parallel ports or USB ports, for example. The method of communication may be wireless or wired.

(3) In the above-described examples, the QR code reader 26 is disposed on the top surface of the printer 20. However, it is also possible to connect a QR code reading device via a proprietary cable, USB cable, or the like so that after the QR code reading device reads a QR code and extracts the information, the device transmits the information to the printer 20.

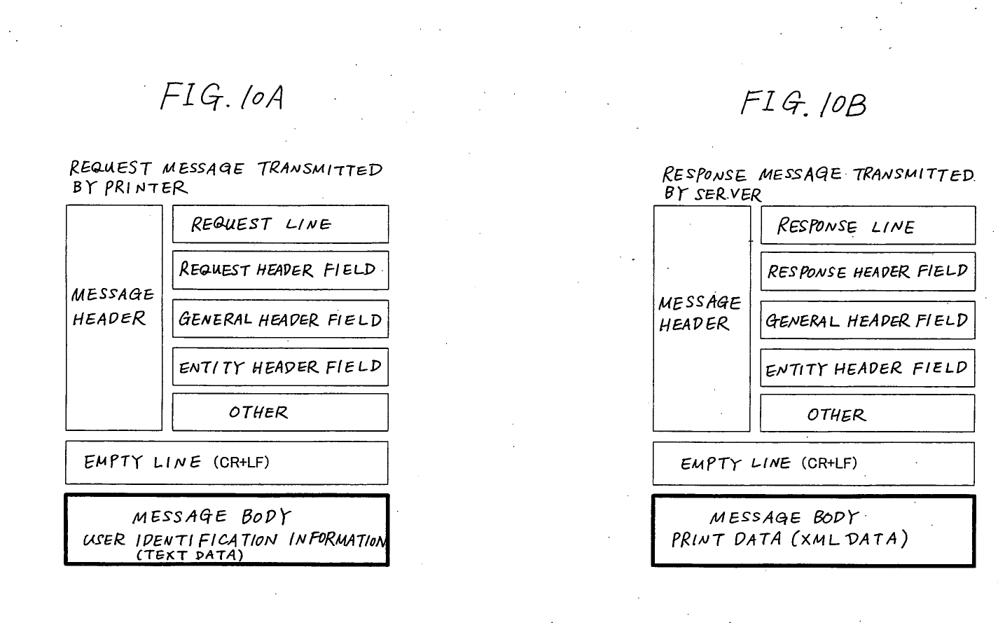

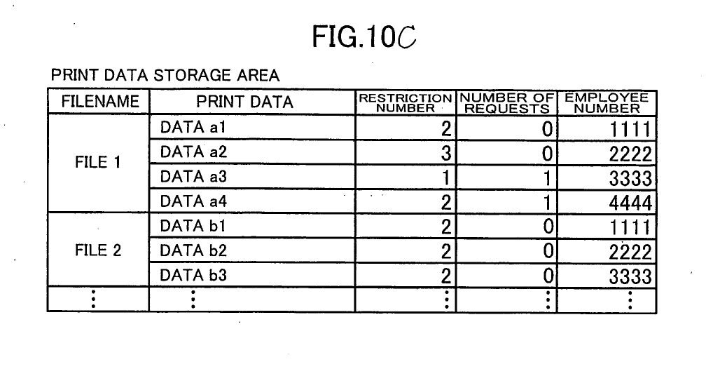

(4) In the above-described examples, user identification information is attached to URL information indicating the saved location of the print data and is transmitted to the server computer 10 as the request message. However, as shown in FIG. 10A, the user identification information may instead be included in a message body of a request message as text data. Note that a message body of a response message shown in FIG. 10B includes print data which is XML data. This format of the response message can also be used in the above-described examples.

(5) FIG. 10C shows a data structure in the print data storage area according to a modification. In this modification, a plurality of data a1, a2, . . . is stored in each file 1, 2, . . . at the saved location indicated by a single URL. User identification information, such as an employee number, is stored in association with each print data. Hence, the CPU 15 reads a file at the saved location based on URL information received from the printer 20 and transmits, to the printer 20, print data out of the plurality of data stored in the file that corresponds to the user identification information received from the printer 20 (for example, the data a1 if the employee number is 1111). In this way, by acquiring user identification information from the printer 20, the CPU 15 can transmit print data corresponding to the user to the printer 20. This construction can be employed in a hospital application, for example, where the printer device transmits patient identification information and URL information for a file storing print data, such as data for a medical record, prescription, or the like, and receives and prints out this print data for the specific patient.

Note that the user identification information, such as an employee number, may also be stored in association with link destination information or storage location information indicating the location of the print data, or other information related to the print data.

(6) In the above-described examples, a restriction is provided for restricting the number of times that a user requests a predetermined print data. However, it is possible to determine a time period in which print data can be provided to a specific user, for example, and to restrict the provision of such print data outside the time period.

(7) In the above-described examples, the server computer 10 uses user identification information obtained from the printer 20 for authorization and the like. However, the user identification information may simply be associated with the requested print data, for example, stored on the hard disk 16 of the server computer 10, and used only for managing users.

(8) In the above-described examples, the printer 20 is used as the printing device. However, the printing device may not only be a laser printer or other printing device, but may also be a facsimile device, or a multifunction device having a printer function, scanner function, and the like.

(9) In the above-described examples, the user identification information includes an employee name, company name, employee number, password, or the like. However, the user identification information may be any other information that can identify or suggest what type of user is requesting data, such as the sex, age, or address of the user, or a combination of two or more thereof.

What is claimed is:

1. A printing system comprising:
a printing device and a server device connected with each other via a communication line, the printing device comprising a request-information transmitting portion that transmits print-data request information to the server device, the server device comprising a print-data providing portion that transmits print data to the printing device in response to the print-data request information received from the printing device,
wherein the printing device further comprises an identification-information transmitting portion that transmits user-identification information to the server device.

2. The printing system according to claim 1, wherein the server device further comprises a determining portion that determines whether provision of print data is restricted or allowed, based on the user-identification information received from the printing device; and
wherein the print-data providing portion transmits the print data to the printing device in response to the determining portion determining that the provision of the print data is allowed.

3. The printing system according to claim 2, wherein the determining portion manages a number of times the user has requested print data based on the user-identification information, and restricts provision of the print data in response to the number of times reaching a predetermined restriction number.

4. The printing system according to claim 2, wherein the printing device further comprises an error-information printing portion that prints error information in response to the determining portion determining that the provision of the print data is restricted.

5. The printing system according to claim 1, wherein the server device further comprises a managing portion that stores a plurality of print data, each of the plurality of print data being associated with one of a plurality of user-identification information; and
wherein the print-data providing portion transmits, to the printing device, print data associated with the user-identification information transmitted from the printing device.

6. The printing system according to claim 1, wherein, in response to the sever device receiving a plurality of print-data request information from the printing device and receives user-identification information in association with at least one of the plurality of print-data request information, the server device determines that all of the plurality of print-data request information correspond to the received user-identification information.

7. The printing system according to claim 1, wherein the printing device further comprises a link-destination reading portion that reads link destination information specifying a link destination of requested print data; and
wherein the request-information transmitting portion generates the print-data request information based on the link destination information read by the link-destination reading portion and transmits the print-data request information to the server device.

8. The printing system according to claim 1, wherein the printing device further comprises an identification-information reading portion that reads the user-identification information; and
wherein the identification-information transmitting portion transmits, to the server device, the user-identification information read by the identification-information reading portion.

9. The printing system according to claim 1, wherein the printing device further comprises:
a storage portion that stores at least one user-identification information; and
a specifying portion that specifies one of the at least one user-identification information,
wherein the identification-information transmitting portion transmits, to the server device, the user-identification information specified by the specifying portion.

10. The printing system according to claim 1, wherein the printing device further comprises:
an image printing portion that prints an image including the user-identification information and link destination information, the link destination information specifying a link destination of requested print data;
a link-destination reading portion that reads the link destination information; and
an identification-information reading portion that reads the user-identification information.

11. The printing system according to claim 1, wherein the link destination information includes a uniform resource locator; and
wherein the identification-information transmitting portion transmits, to the server device, the user-identification information attached to the uniform resource locator.

12. The printing system according to claim 1, wherein the server device transmits an authorization request to the printing device in response to the requested print data requiring user authorization;
wherein, upon receiving the authorization request from the server device, the identification-information transmitting portion transmits the user identification information to the server device, the user identification information serving as authorization information; and
wherein, upon receiving valid authorization information from the printing device, the print-data providing portion transmits the print data to the printing device.

13. The printing system according to claim 12, wherein the printing device requests the user to input a password, upon receiving the authorization request from the server device; and
wherein the identification-information transmitting portion transmits, to the server device, the password as the authorization information.

14. The printing system according to claim 1, wherein the identification-information transmitting portion transmits the user-identification information to the server device in process of receiving the print data from the server device.

15. The printing system according to claim 1, wherein the sever device further comprises a storage portion that stores the user-identification information in association with the print data.

16. A printing device comprising:
a request-information transmitting portion that transmits print-data request information to a server device connected with the printing device via a communication line; and
an identification-information transmitting portion that transmits user-identification information to the server device.

17. A server device comprising:
a print-data providing portion that transmits print data, to a printing device connected with the server device via a communication line, in response to print-data request information transmitted from the printing device; and
an acquiring portion that acquires user-identification information transmitted from the printing device in association with the print data.

18. A storage medium for storing a program for a printing device, the program comprising:
a program of transmitting print-data request information to a server device connected with the printing device via a communication line; and
a program of transmitting user-identification information to the server device.

19. A storage medium for storing a program for a server device, the program comprising:
a program of transmitting print data, to a printing device connected with the server device via a communication line, in response to print-data request information transmitted from the printing device; and
a program of acquiring user identification information transmitted from the printing device in association with the print data.
